(19) United States
(12) Patent Application Publication
(10) Pub. No.: US 2017/0320017 A1
(43) Pub. Date: Nov. 9, 2017

(54) Purified water storage device

(71) Applicant: Yongbin Yue, Xiamen City (CN)

(72) Inventor: Yongbin Yue, Xiamen City (CN)

(21) Appl. No.: 15/033,102

(22) PCT Filed: Apr. 13, 2015
(86) PCT No.: PCT/CN2015/076404

§ 371 Date: Apr. 28, 2016

(30) Foreign Application Priority Data
Jan. 29, 2015 (CN) 201510045114.2
Jan. 29, 2015 (CN) 201520061918.7

(51) Int. Cl. B01D 61/10; F15B 1/26; B01D 61/12; B01D 65/00; E03B 1/04

(52) U.S. Cl. CPC B01D 61/10; B01D 65/006; E03B 1/04; B01D 61/12; F15B 1/26; B01D 2313/16; B01D 2313/18

(57) ABSTRACT

A purified water storage device includes a container including a cover, a bladder having a top secured to the cover and a bottom secured to a through hole of the container, a pipe for both venting and draining having an end connected to the bladder and communicating therewith, the pipe including a check valve, a water pipe having an end connected to the bottom of the bladder and communicating therewith, and a level sensor disposed externally of the container and having an end connected to the bottom of the bladder and communicating therewith. The watertight bladder is made of thermoplastic for medical or food purposes. The bladder can be replaced after a predetermined times of use rather than regular cleaning. Venting is carried out and overflow is prevented. The device has the same effect as an open container. Its material is safe and cleanness can be maintained.

### BACKGROUND OF THE INVENTION

### 1. Field of the Invention

The invention relates to purified water storage and more particularly to a purified water storage device having improved characteristics.

### 2. Description of Related Art

Purified water is tap water or natural water that has been mechanically filtered by reverse osmosis or processed by ion exchange to remove impurities and makes it suitable for use. Purified water is usually not consumed immediately after being produced. It is typically stored in containers prior to use. Harmful contaminants (e.g., particulates, inorganic compounds, organic compounds, and bacteria) are substantially removed from purified water. Thus, quality of containers for storing purified water is required to be very high. Currently, a number of purified water containers are commercially available as detailed below.

The first type is non-pressure container which is made of polyethylene (PE) or stainless steel. For removing contaminants in a container, it is typical that submersion ultraviolet (UV), regular cleaning or disinfection is performed. Further, for preventing the sealed container being contaminated by air pollution, it is typical that filters for removing microorganisms and CO₂, or cleaning inner surface are used. It is hoped that the growth of microorganisms can be decreased greatly. However, these conventional methods have the following disadvantages: Cleaning is labor intensive. Submersion UV is cost prohibitive and low efficiency. Sealing the container may cause the following problems including how to solve overflow of the container (this may install additional high level sensor), regular cleaning and replacement of filers, and regular cleaning by means of clean-in-place (CIP) devices. Regarding PE containers, they have coarse surfaces due to the manufacturing processes. Thus, microorganisms may grow on the surface. Therefore, more frequent cleanings are required for the PE containers.

The second type is pressurized container (so called pressure container) which is made of rigid material with an air inflatable bladder disposed therein. The bladder is filled with air. The bladder will be elastically deformed and internal air is compressed after filling with water. As a result, the bladder is filled with air. It is advantageous for no communication between the internal water and the external air. Thus, pollutants in the external air are prevented from entering the container. This type pressure container is the best choice for storing purified water. However, microorganisms may grow in the pressure container after a period time of use. Further, it is very difficult of cleaning internal components of the container because it is impossible of opening the sealed container. Furthermore, the component for storing water is disposed inside the container and it is impossible of determining whether material of the component is safe or not. Moreover, pressure inside the bladder may increase greatly while filling water into the container and the increased pressure may interfere with the storage and to the worse may consume more energy. In addition, constant outflow of purified water for consumption is not possible due to changing pressure inside the bladder. This is disadvantageous when constant, reliable water supply is desired. Finally, air cannot be effectively expelled out of the pressure container. In detail, air may be dissolved in water when the bladder is filled with purified water and more air may be dissolved as pressure increases. And in turn, purified water supplied from the container may be murky and a great number of bubbles in the water is disadvantageous for downstream devices.

In view of the above, the typical purified water storage devices are disadvantageous due to the following drawbacks: Difficult of being cleaned. Excessive number of components and high cost due to prevention of air pollution. Materials of the container are not reliable in terms of cleanness and smoothness of inner surface is not acceptable. The sealed container has problems of increased pressure, inconstant outflow, and bubbles in terms of storage and supply.

### SUMMARY OF THE INVENTION

For solving problems associated with the prior art, the invention provides a purified water storage device. The bladder can be replaced after a predetermined times of use rather than regular cleaning. The purified water is free from being polluted by air in a one-way flow path (i.e., air outflow permitted and air inflow prohibited). Venting is carried out and overflow is prevented. No additional equipment is required. The bladder in the container may flexibly deform to overcome problems of pressure change and inconstant flow. The device has the same effect as an open container. The flexible bladder is made of thermoplastic (e.g., PE) for medical or food purposes. Its material is safe and cleanness can be maintained.

For achieving above objects, the invention provides a purified water storage device comprising a rigid container including a cover on a top and a through hole in a bottom; a flexible bladder having a top secured to the cover and a bottom secured to the through hole of the container; a pipe for both venting and draining having a first end connected to the top of the bladder and communicating therewith, the pipe for both venting and draining including a check valve distal the first end thereof; a water pipe having a first end connected to the bottom of the bladder and communicating therewith; and a level sensor disposed externally of the container and having a first end connected to the bottom of the bladder and communicating therewith; wherein the bladder is made of thermoplastic (e.g., PE) for medical or food purposes.

In the purified water storage device, the top and the bottom of the bladder are secured to the container respectively and in an empty state the bladder stands upright in the container.

In the purified water storage device, in response to filling purified water into the bladder via the water pipe, water gradually rises in the bladder to deform the bladder into a cylindrical shape, an outer diameter of the fully expanded bladder is greater than an inner diameter of the container, and the outer diameter of the fully expanded bladder is at least 110% greater than the inner diameter of the container.

In the purified water storage device, a plastic tubing part is mounted through the cover, an internally threaded hole is disposed at the top of the bladder, an externally threaded connector is disposed at the bottom of the bladder, the plastic tubing part is secured to the internally threaded hole, and the externally threaded connector is fastened in a hole on a bottom of the container.

In the purified water storage device, further comprises a base disposed below the container for supporting the container, and wherein the water pipe and the level sensor are disposed within the base.

In comparison with the conventional purified water storage device or method, the invention has the following advantages:

It is neither a non-pressure container nor a pressurized container of the conventional art. In comparison with the conventional non-pressure container, it has an internal bladder for storing water, and the bladder does not contact an inner surface of the container. In comparison with the conventional pressurized container, while it has an internal bladder for storing purified water, the bladder of the conventional pressurized container is for storing air. Further, air injection into the bladder of the invention prior to water storage is not required. Outflow of the stored purified water is carried out by gravitational force thereof rather than by internal pressure of the bladder.

For removing contaminants, no filter is installed by the invention. Further, regular cleaning and disinfection are not required, and overflow protection devices of high cost are not required.

The following beneficial effects of the invention can be obtained:

Quality of the bladder is safe and reliable. For example, the bladder is made of thermoplastic (e.g., PE) for medical or food purposes. The manufacturing processes of the bladder are much less polluted in comparison with the conventional manufacturing processes of bladder made of plastics or metal. Also, it has a smooth surface and processing prior to use is not required.

Cost and operation requirements are much less than CIP cleaning and disinfection.

Replacements of filter and UV lamp are not required. Installation of additional equipment is not required. Buying and use cost are greatly decreased.

Check valve allows one way flow of air and drain. Thus, pollutants in the air and CO₂ are prevented from entering the bladder. Air dissolved in the purified water can be effectively expelled in the process of outflow. Air is prevented from entering downstream consumption devices via the water pipe in the bottom of the bladder.

The bladder is airtight. In comparison with the conventional pressurized container, the device can supply purified water in a constant flow. This is particularly beneficial to downstream consumption devices which are required to be reliable and high in efficiency.

Finally, requirements of the plastic container of the invention are very low. The container only serves as an enclosure. A container made of any material and having one of a number of different shapes is permitted.

The above and other objects, features and advantages of the invention will become apparent from the following detailed description taken with the accompanying drawings.

### BRIEF DESCRIPTION OF THE DRAWINGS

FIG. 1 schematically depicts a purified water storage device according to the invention;

FIG. 2A is a schematic side view of the purified water storage device; and

FIG. 2B is a view similar to FIG. 1 showing the device full of purified water.

### DETAILED DESCRIPTION OF THE INVENTION

For better understanding technical problems to be solved by the invention, technical solutions of the invention, and advantageous effects of the invention, reference will now be made by way of example to the accompanying drawings taken with preferred embodiments. Those skilled in the art will recognize that the preferred embodiments are for describing the invention and the invention is not limited to the preferred embodiments.

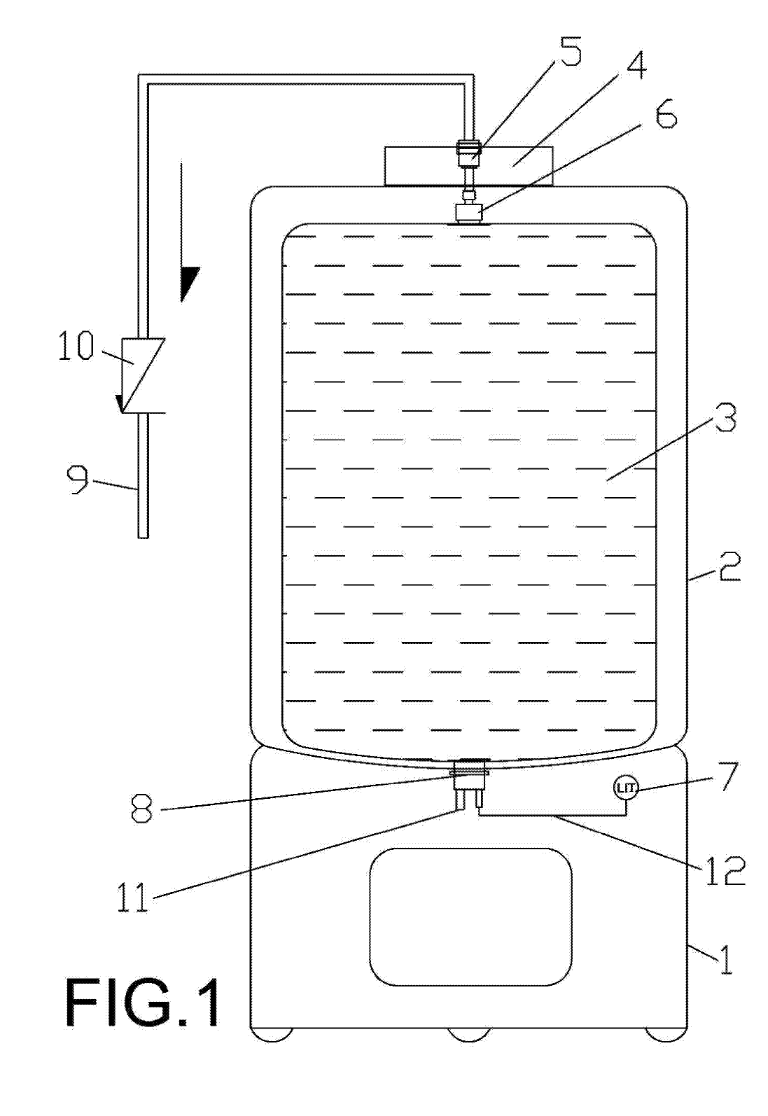

Referring to FIG. 1, a purified water storage device in accordance with the invention comprises a base 1, a container 2 on the base 1, and a flexible bladder 3 fastened in the container 2 as discussed in detail below.

The container 2 is made of rigid material such as thermosetting polymer (plastic). A cover 4 is provided on a top of the container 2. A hole is formed through the cover 4. A component is mounted in the hole. The component is a plastic tubing part 5. A through hole is provided on a bottom of the container 2. The container 2 aims at increasing resistance of the bladder 3 to pressure of water stored in the bladder 3, thereby preventing the bladder 3 from being broken.

The flexible bladder 3 is fastened in the container 2. The bladder 3 is made of thermoplastic such as PE for medical or food purposes.

Top of the bladder 3 is provided with an internally threaded hole 6 having watertight and pressure resistant characteristics. Bottom of the bladder 3 is provided with an externally threaded connector 8 which is fastened in a hole of the container 2. One ends of a large water pipe 11 and a small hose 12 are connected to the externally threaded connector 8 respectively. A level sensor 7 is provided at the other end of the hose 12. The level sensor 7 may sense liquid levels in the bladder 3 by taking advantage of the principle which states that pressure exerted anywhere in a confined incompressible fluid is transmitted equally in all directions throughout the fluid such that the pressure variations. The sensed level is converted into a signal which is in turn sent to a controller for controlling opening or close of water entering the bladder 3 via a port at bottom of the bladder 3. The water pipe 11 at the externally threaded connector 8 serves as inflow port or outflow port. The plastic tubing part 5 is secured to the internally threaded hole 6 on top of the bladder 3 so that the bladder 3 may stand upright without being bent.

A pipe 9 has one end connected to the plastic tubing part 5 which communicates with inside of the bladder 3 via the internally threaded hole 6 on the top of the bladder 3. Air and water in the bladder 3 can flow out via the pipe 9. That is, the pipe 9 serves as both a drain pipe and a vent pipe. A check valve (i.e., one-way valve) 10 is provided in the pipe 9 to only allow water to flow out of the bladder 3. The base 1 is used to increase elevation of the purified water storage device so that water in the bladder 3 may have increased potential kinetic energy for ease of outflow. The water pipe 11, the hose 12, and the level sensor 7 are disposed in the internal space of the base 1.

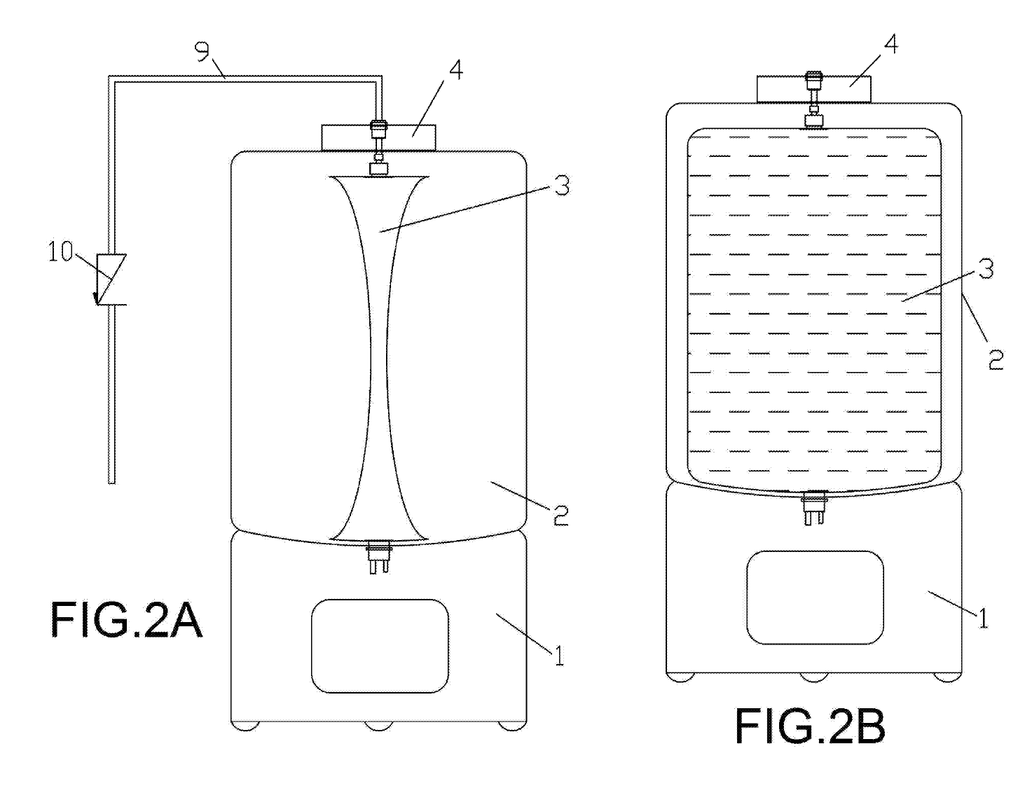

Referring to FIGS. 2A and 2B in conjunction with FIG. 1, water filling and water discharging of the purified water storage device of the invention are illustrated below.

Initially, the bladder 3 is empty. The plastic tubing part 5 through the cover 4 and the internally threaded hole 6 on the top of the bladder 3 are secured together. The externally threaded connector 8 at the bottom of the bladder 3 is fastened in a hole of the container 2. Thus, the bladder 3 stands upright with respect to a central vertical line of the container 2. Also, very little air exists in the bladder 3.

Next, purified water fills into the bladder 3 via the water pipe 11 at the bottom of the bladder 3. Water gradually rises in the bladder 3 to deform the bladder 3 into a columnar shape. The outer diameter of the fully expanded bladder 3 is greater than the inner diameter of the container 2. Specifically, the outer diameter of the fully expanded bladder 3 is at least 110% greater than the inner diameter of the container 2.

After level reaching a predetermined height, air may rise to fill an upper portion of the bladder 3 if there is air in the water. Further, the air may be expelled out of the bladder 3 via the internally threaded hole 6, the pipe 9 and the check valve 10.

After level reaching the predetermined height, the level sensor 7 may stop the inflow. Also, the air in the upper portion of the bladder 3 does not interfere with the generation of a level signal by the level sensor 7.

In response to a water supply need from a downstream consumption device, purified water in the bladder 3 may flow out of the bladder 3 to the consumption device via the water pipe 11 due to its higher elevation or a pumping operation. The flexible nature of the bladder 3 may not interfere with the outflow. Also, external air may not be sucked into the bladder 3 due to the provision of the check valve 10. Otherwise, pollutants in the external air may contaminate purified water stored in the bladder 3.

The outflow will continue until very little air exists in the empty bladder 3. The filling may not stop after the bladder 3 being fully filled with purified water due to malfunction of the level sensor 7 and/or an upstream purified water supply. Advantageously, excess water may flow out of the bladder 3 via the pipe 9 to prevent overflow from occurring on the ground.

The bladder 3 can be replaced with a new one after a period time of use. This is because the bladder 3 may be contaminated. Water in the bladder 3 may be discharged, disengage the bladder 3 from the container 2, and remove the bladder 3 by opening the cover 4 are steps of the replacement. After the removal, the new bladder 3 can be installed by performing steps reverse to that described above.

While the invention has been described in terms of preferred embodiments, those skilled in the art will recognize that the invention can be practiced with modifications within the spirit and scope of the appended claims.

What is claimed is:

1. A purified water storage device comprising:
a rigid container including a cover on a top and a through hole in a bottom;
a flexible bladder having a top secured to the cover and a bottom secured to the through hole of the container;
a pipe for both venting and draining having a first end connected to the top of the bladder and communicating therewith, the pipe for both venting and draining including a check valve distal the first end thereof;
a water pipe having a first end connected to the bottom of the bladder and communicating therewith; and
a level sensor disposed externally of the container and having a first end connected to the bottom of the bladder and communicating therewith;
wherein the bladder is made of thermoplastic for medical or food purposes.

2. The purified water storage device of claim 1, wherein the top and the bottom of the bladder are secured to the container respectively and wherein in an empty state the bladder stands upright in the container.

3. The purified water storage device of claim 1, wherein in response to filling purified water into the bladder via the water pipe, water gradually rises in the bladder to deform the bladder into a cylindrical shape, wherein an outer diameter of the fully expanded bladder is greater than an inner diameter of the container, and wherein the outer diameter of the fully expanded bladder is at least 110% greater than the inner diameter of the container.

4. The purified water storage device of claim 1, wherein a plastic tubing part is mounted through the cover, an internally threaded hole is disposed at the top of the bladder, an externally threaded connector is disposed at the bottom of the bladder, the plastic tubing part is secured to the internally threaded hole, and the externally threaded connector is fastened in a hole on a bottom of the container.

5. The purified water storage device of claim 3, wherein a plastic tubing part is mounted through the cover, an internally threaded hole is disposed at the top of the bladder, an externally threaded connector is disposed at the bottom of the bladder, the plastic tubing part is secured to the internally threaded hole, and the externally threaded connector is fastened in a hole on a bottom of the container.

6. The purified water storage device of claim 1, further comprising a base disposed below the container for supporting the container, and wherein the water pipe and the level sensor are disposed within the base.

7. The purified water storage device of claim 3, further comprising a base disposed below the container for supporting the container, and wherein the water pipe and the level sensor are disposed within the base.

8. The purified water storage device of claim 4, further comprising a base disposed below the container for supporting the container, and wherein the water pipe and the level sensor are disposed within the base.

9. The purified water storage device of claim 5, further comprising a base disposed below the container for supporting the container, and wherein the water pipe and the level sensor are disposed within the base.
